(19) United States
(12) Patent Application Publication
(10) Pub. No.: US 2007/0174384 A1
(43) Pub. Date: Jul. 26, 2007

(54) Sidebar communication system and method

(76) Inventors: John Abd-El-Malek, Sunnyvale, CA (US); Omar Khan, San Francisco, CA (US)

Correspondence Address: FISH & RICHARDSON P.C., PO BOX 1022, MINNEAPOLIS, MN, 55440-1022, US

(21) Appl. No.: 11/339,322

(22) Filed: Jan. 25, 2006

(51) Int. Cl. G06F 15/16

(52) U.S. Cl. 709/203

(57) ABSTRACT

A computer implemented method is described. The method includes receiving an event associated with a user selection of an item displayed by a sidebar application running on a first client. The sidebar application being an application that is configurable to aggregate multiple types of items from sources external to the sidebar application. The method also includes receiving an identifier associated with an external client, the external client being different from the first client, and initiating, using the sidebar application, transmission of the item to the external client.

### TECHNICAL FIELD

This document relates to a sidebar communication system and method.

### BACKGROUND

As use of the Internet and the amount of digital information has increased, the formats and sources of this information have also increased. A typical user can access several types of digital information using several different applications on a daily basis. For example, a user may access email messages with an email client, view digital photographs with an image viewer, and read the latest news from websites using a web browser.

Some systems include applications, called sidebar applications, which permit a user to view data in various formats and from various sources in a central display. Sharing the aggregated items with others may, however, be difficult. For example, if the user wanted to share a news item from the sidebar applications, the user may have to select the item, which may initiate viewing the item in a web browser. The user may then have to select and copy a uniform resource locator (URL) of a web page that includes the news item. After the URL is copied, the user may open an email client application, paste the URL into the body, select a recipient, and finally send the email to the recipient. This process may be necessary for each item the user desires to share with others.

### SUMMARY

This document discloses methods and systems that enable a sidebar application on a first client to communicate with applications on a second client.

In one aspect, a computer implemented method is described. The method includes receiving an event associated with a user selection of an item displayed by a sidebar application running on a first client. The sidebar application being an application that is configurable to aggregate multiple types of items from sources external to the sidebar application. The method also includes receiving an identifier associated with an external client, the external client being different from the first client, and initiating, using the sidebar application, transmission of the item to the external client.

In one example, the method also includes selecting an application on the external client to receive the item. The application on the external client can be another sidebar application, an email client, or an instant messaging client. The other sidebar application can be configured to display the received item in a prominent manner. The other sidebar application can also be configured to decrease the prominence of the received item after the received item is selected by a user of the other sidebar application. The item can be a plug-in panel for the sidebar application, and the item can be managed by a plug-in panel for the sidebar application. The item may include information that is encoded as a string. The item can be selected from a group consisting of text from rich site summary (RSS) transmissions, email messages, web pages, digital images, and interactive game movements.

In another example, the sidebar application may use plug-ins to aggregate the multiple types of items. Each plug-in can use the sidebar application to transmit items managed by the plug-in to the external client. Transmitting the item may include the sidebar application accessing a communication interface of a second separate application. The separate application can transmit the item to the external client. The second separate application can be an instant messaging application.

Also, transmitting the item may include using a communication interface that is integrated with the sidebar application for transmitting the item. The method can also include transmitting an identifier associated with the sender of the item, and terminating the transmission of the item if a user of the external client does not authorize acceptance of the transmission. Transmitting the item may include transmitting the item from the first client to a server and from the server to the external client. The method can include receiving at the first client a received item from another sidebar application on the external client and displaying the received item using the sidebar application running on the first client.

In a second aspect, a system is described. The system includes a sidebar application configurable to aggregate for display multiple types of items received from sources external to the sidebar application, a user interface of the sidebar application operable to receive from a user an input selecting an item and an input selecting an external client to receive the item, and means for transmitting the item from the sidebar application on a first client to the external client. The sidebar application may include plug-ins that manage the items. The means for transmitting can be included in an application separate from the sidebar application, the means being used by the sidebar application to transmit the item to the external client.

The systems and techniques described here may provide one or more of the following advantages. A system may provide improved convenience and efficiency in transmitting information displayed by a sidebar application. Also, a system may increase plug-in capabilities by providing an existing communication structure that plug-ins for a sidebar application can use to transmit their content. Such a system may encapsulate the complexity of the communication structure while exposing its functionality to the plug-ins. A system may also increase the communication capability of sidebar applications by enabling transmission of sidebar content to several different types of applications.

The details of one or more embodiments are set forth in the accompanying drawings and the description below. Other features, aspects, and advantages of the described embodiments will be apparent from the description and drawings, and from the claims.

### DESCRIPTION OF DRAWINGS

FIG. 1 is a schematic diagram of an example of a system for sharing content from a sidebar application with another application.

FIG. 2 is a block diagram of the sidebar content sharing system of FIG. 1 shown in more detail.

FIG. 3 is a flow chart of an example method for sharing content from a sidebar application with another application.

FIG. 4 is an example of a user interface (UI) of one implementation of a sidebar application showing content to be shared.

FIG. 5 is an example of the sidebar application UI showing content that has been shared.

FIG. 6A is an example of a sidebar application UI showing shared content that has been received.

FIG. 6B is an example of the sidebar application UI showing shared content that has been received and marked as read.

FIG. 7 is an example of an instant message application UI showing shared content that has been received.

FIG. 8 is a schematic diagram of an example of a generic computer system.

Like reference symbols in the various drawings indicate like elements.

### DETAILED DESCRIPTION

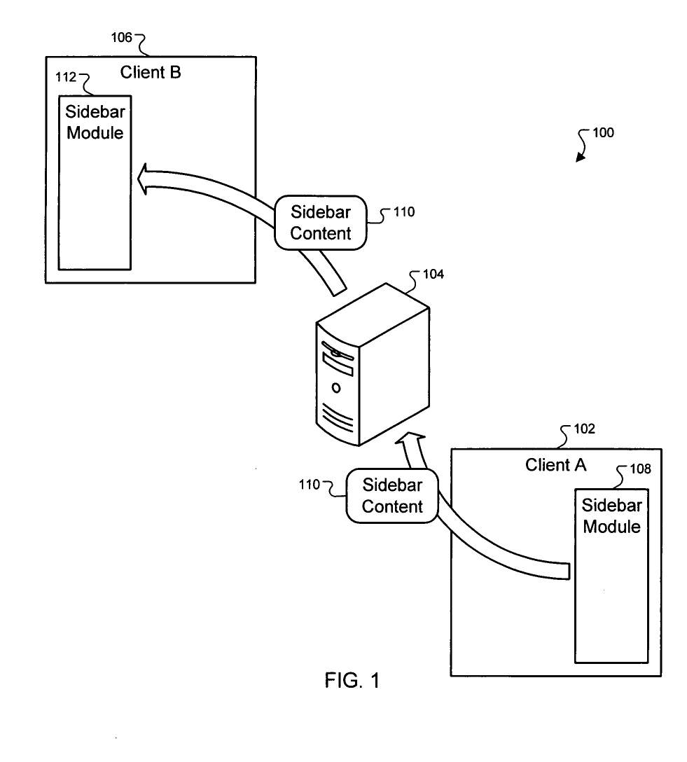

FIG. 1 shows a system 100 that permits a user on a first computer to communicate and share information displayed on a sidebar with a user on a different computer. The sidebar application installed on the first computer can gather information from several sources, both local and external to the first computer. The sidebar's display of information from multiple sources can provide the user of the first computer with a single centralized application that displays many items of interest to the user. For example, the sidebar application can display digital photographs stored on the user's computer in one section of the sidebar application, email messages from the user's email account in another section, and rich site summary (RSS) feeds from news websites in yet another section of the sidebar. Using the system 100, the user of the first computer may select one of the items of interest displayed on the sidebar and transmit it to the user of the second computer.

More specifically, FIG. 1 is a schematic diagram of an example of the system 100 for sharing content from a sidebar application with another application. The system 100 includes a client A 102, a server 104, and a client B 106. In general, the client A 102 includes a sidebar module 108 that is capable of transmitting sidebar content 110 to an application of the client B 106, such as another sidebar module 112. In some implementations, the application of client B can be an email client or an instant messaging client. Also, in other implementations, the sidebar content 110 is first transmitted to the server 104 and then the server 104 transmits the sidebar content 110 to the application of the client B 106.

As described above, the sidebar module 108 can aggregate one or more items of interest from sources external and local to the sidebar module 108, such as email from an email client, news from a news server, or pictures from a repository. The sidebar module 108 receives an event associated with the user selection of an item of interest, such as a particular news article, displayed by the sidebar module 108. The sidebar module 108 also receives an identifier associated with an external client, such as the client B 106, to receive the item of interest. The sidebar module 108 of the client A 102 transmits the sidebar content 110, which includes the item of interest, to the sidebar module 112 of the client B 106 using the server 104 to receive the item of interest from the client A 102 and transmit it to the client B 106. In some implementations, the server 104 stores the sidebar content 110 received from the client A 102 until the sidebar module 112 requests that it be transmitted. In addition, the client A 102 may receive an item of interest from an application of the client B 106 and present the item of interest using the sidebar module 108.

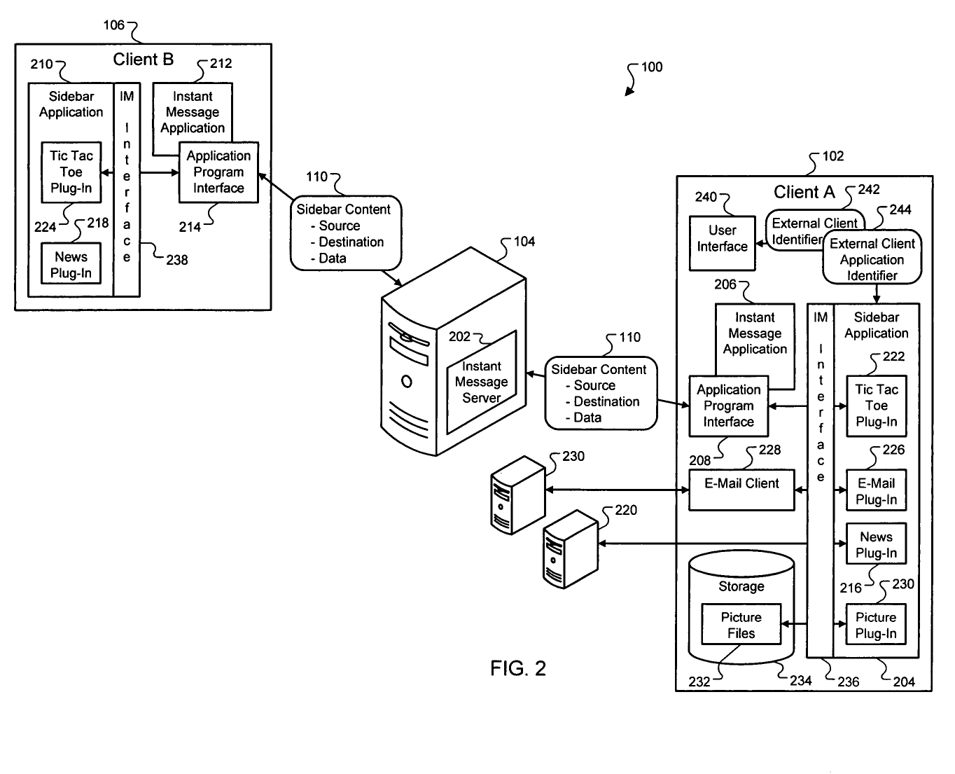

FIG. 2 is a block diagram of the sidebar content sharing system 100 of FIG. 1 shown in more detail. The server 104 includes an instant message (IM) server 202 that receives the sidebar content 110 from the client A 102 and transmits the sidebar content 110 to the client B 106. The client A 102 includes a sidebar application 204 for presenting items of interest and an instant message application 206 for transmitting instant messages. The instant message application 206 has an associated instant message application program interface (API) 208 accessible by other applications in addition to the instant message application 206. The instant message API 208 may use proprietary protocols for instant message communication or open protocols, such as Extensible Messaging and Presence Protocol (XMPP), or a combination thereof. The sidebar application 204 or sub-components of the sidebar application 204 can transmit items of interest to the client B 106 using the IM API 208. The sidebar content 110 may contain data that represents the item of interest as well as other information used by the IM API 208, such as a source identifier or address and a destination identifier or address. Similarly, the client B 106 includes a sidebar application 210, an instant message application 212, and an IM API 214. The sidebar application 210 or sub-components of the sidebar application 210 may use the IM API 214 to receive the sidebar content 110 from the client A 102 via the server 104.

The sidebar applications 204 and 210 may include plug-ins that manage the items of interest. For example, the sidebar applications 204 may include news plug-ins, tic-tac-toe plug-ins, email plug-ins, and picture plug-ins. News plug-ins 216 and 218 may receive news articles from a Rich Site Summary (RSS) server 220 and present the news articles to the user. Tic-tac-toe plug-ins 222 and 224 may allow users of the client A 102 and the client B 106 to play a game of tic-tac-toe using the sidebar applications 204 and 210. An email plug-in 226 may use an email client 228 to retrieve emails from an email server 230 and present them to the user. A picture plug-in 230 may retrieve picture files 232 from storage 234 and present them to the user. The sidebar application 204 may transmit the items of interest presented by the plug-ins to the client B 106 using the IM API 208 and the server 104. For example, an item of interest may be an RSS news article, an email message, a web page, a digital image, or an interactive game movement. In some implementations, the item of interest transmitted to the client B 106 may be the plug-in itself. Additionally, if the sidebar application 210 of the client B 106 receives an item of interest for which it does not have an associated plug-in, it may retrieve the plug-in, for example, from the client A 102 or the server 104.

In some implementations, the user of the client B 106 may block transmission of items of interest that are not authorized by the user. For example, the IM API 214 may include a list of users or clients that are allowed or not allowed to send items of interest to the client B 106 or the user of the client B 106. In addition, the IM API 214 may include a list of content types that the user allows to be transmitted to the client B 106. For example, the user may allow RSS news and pictures and not allow plug-ins.

The sidebar applications 204 and 210 and their plug-ins use IM interfaces 236 and 238 that are integrated with the sidebar applications 204 and 210, respectively. The IM interfaces 236 and 238 provide services to the plug-ins, such as communication to the IM API 208 and 214, communication to the email client 228, communication to the RSS server 220, and access to the picture files 232. Alternatively, the IM interfaces 236 and 238 may perform the communication to the instant message server 202 directly, without the IM API 208 and 214.

The client A 102 includes a user interface 240. The sidebar application 204 and its plug-ins may interact with the user of the client A 102 via the user interface 240. For example, the user interface 240 may include a control that allows the user to input an external client identifier 242, such as an identifier of the client B 106, to select a destination for an item of interest. The user interface 240 may also include a control that allows the user to input an external client application identifier 244, such as an identifier of the sidebar application 210, to select an application on the selected destination for the item of interest. In some implementations, the input controls may be pop-up menus initiated by right clicking on an item of interest using a pointing device.

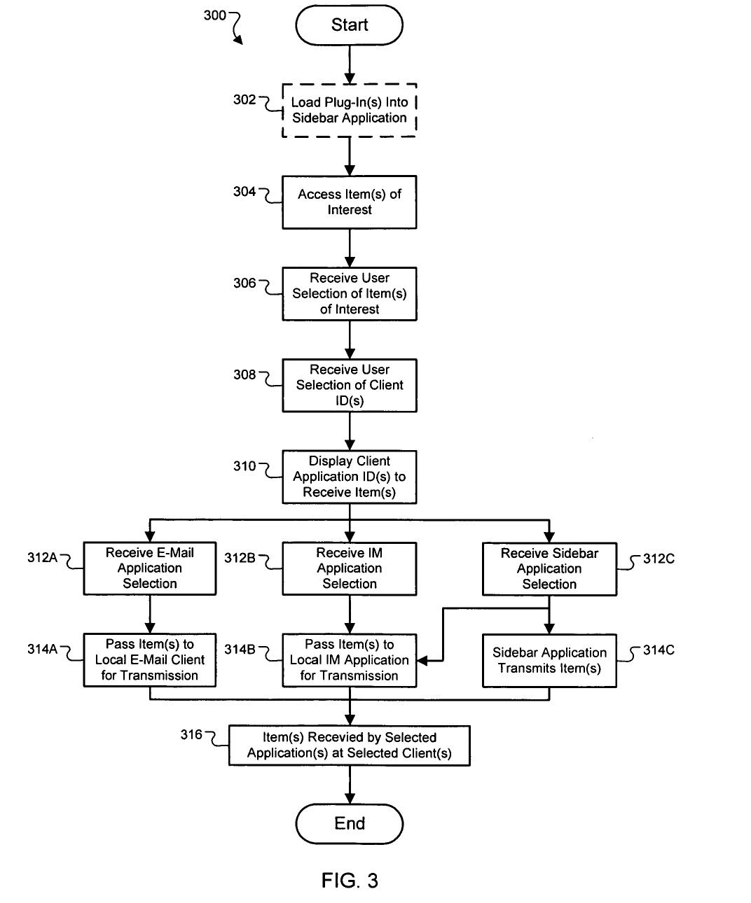

FIG. 3 is a flow chart of an example of a method 300 for sharing content from a sidebar application with another application. The method 300 may be performed, for example, by a system such as the system 100 and, for clarity of presentation, the description that follows uses the system 100 as the basis of an example for describing the method 300. However, another system, or combination of systems, may be used to perform the method 300.

The method 300 begins with optional step 302 where one or more plug-ins are loaded into a sidebar application. For example, the sidebar application 204 may load the tic-tac-toe plug-in 222, the email plug-in 226, the news plug-in 216, and the picture plug-in 230. At step 304, one or more items of interest are accessed. For example, the email plug-in 226 may retrieve email messages from the email server 230 using the email client 228, the news plug-in 216 may retrieve news articles from the RSS server 220, the picture plug-in 230 may retrieve the picture files 232 from the storage 234, and tic-tac-toe plug-in 222 may retrieve the opponent's moves from the server 104.

A user selection of one or more items of interest is received, at step 306. For example, the sidebar application 204 may receive the user selection of a news item using the UI 240. At step 308, a user selection of a client identifier (ID) or identifiers is received. For example, the sidebar application 204 may receive the user selection of the identifier for the client B 106.

One or more client application identifiers are displayed, at step 310. For example, the sidebar application 204 generates the UI 240 that displays a list of client application identifiers that may include an email application identifier, an instant message application identifier, and a sidebar application identifier. At steps 312A, 312B, and 312C, an email application identifier, an instant message application identifier, and a sidebar application identifier are received, respectively. For example, the sidebar application 204 may receive a “Sidebar” selection from the client application identifier list.

If an email application identifier is selected, then, at step 314A, the one or more items are passed to an email client for transmission. For example, the sidebar application 204 may pass the news item to the email client 228 to be sent to the client B 106 via email. If an instant message application identifier is selected, then the one or more items are passed, at step 314B, to an instant message application for transmission. For example, the sidebar application 204 may pass the news item to the instant message application 206 or the IM API 208 to be sent to the client B 106 via IM. In some implementations, if a sidebar application identifier is selected, then the one or more items are passed to an instant message application for transmission. Alternatively, the sidebar application may transmit the one or more items itself. For example, the sidebar application 204 may transmit the news item to the client B 106 via the server 104.

At step 316, the one or more selected items are received at the one or more selected clients by the one or more selected client applications. For example, the sidebar application 210 at the client B 106 may receive the news item. In another example, the instant message application 212 at the client B 106 may receive the news item.

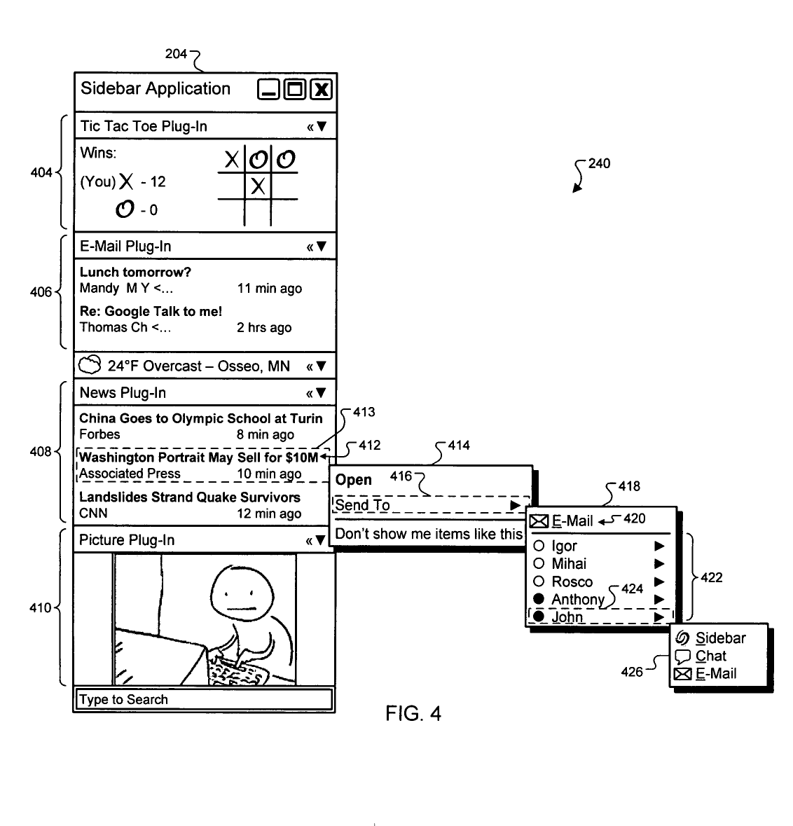

FIG. 4 is an example of the user interface (UI) 240 of the sidebar application showing content to be shared. The UI 240 includes the sidebar application area 204. The sidebar application area 204 includes a tic-tac-toe plug-in area 404, an email plug-in area 406, a news plug-in area 408, and a picture plug-in area 410, which are generated by the tic-tac-toe plug-in 222, the email plug-in 226, the news plug-in 216, and the picture plug-in 230, respectively. Each plug-in area presents items of interest that are managed by that plug-in.

The user may select an item of interest, such as a news article 412 regarding the sale of a portrait, to transmit to an external client, where the selection is indicated by the dashed line 413. The selection may initiate the pop-up menu 414 that presents available options regarding the item of interest. The user may select a “Send To” option, as indicated by the dashed line 416, to transmit the item of interest to an external client. This may initiate another pop-menu 418 that presents contacts or clients to which the item of interest may be sent. An “Email” option 420 allows the user to input an email address to which the item of interest may be sent. The menu 418 also includes a list 422 that includes contacts of the user. The user may select a contact to transmit the item of interest to, as indicated by the dashed line 424. This may initiate a pop-menu 426 where the user may select the application of the contact to which the item of interest will be directed, such as a sidebar application, an instant message application, or an email application.

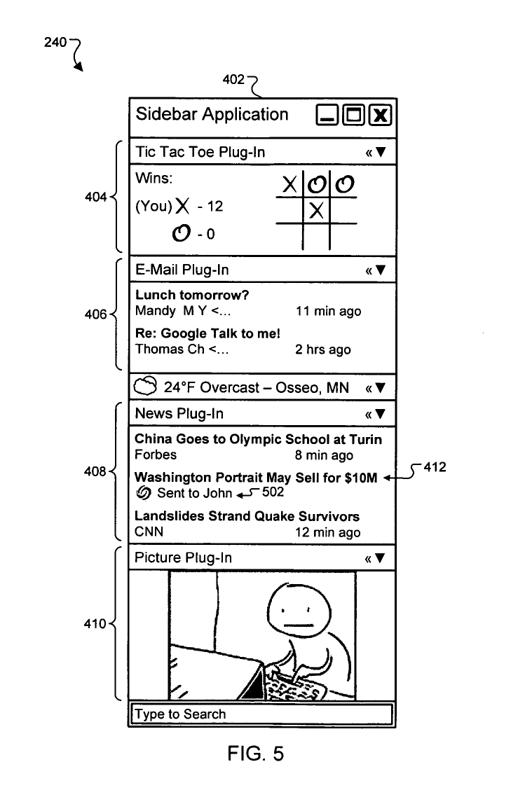

FIG. 5 is an example of the sidebar application UI 240 showing content that has been shared. In some implementations, the UI 240 may be updated to reflect the transmission of an item of interest to another user. Here, the news plug-in area 408 has been updated to include text 502 indicating that the portrait sale item of interest 412 has been sent to the contact “John.” Alternatively, the text 502 may be appended to the item of interest 412 rather than replacing the source of the news article.

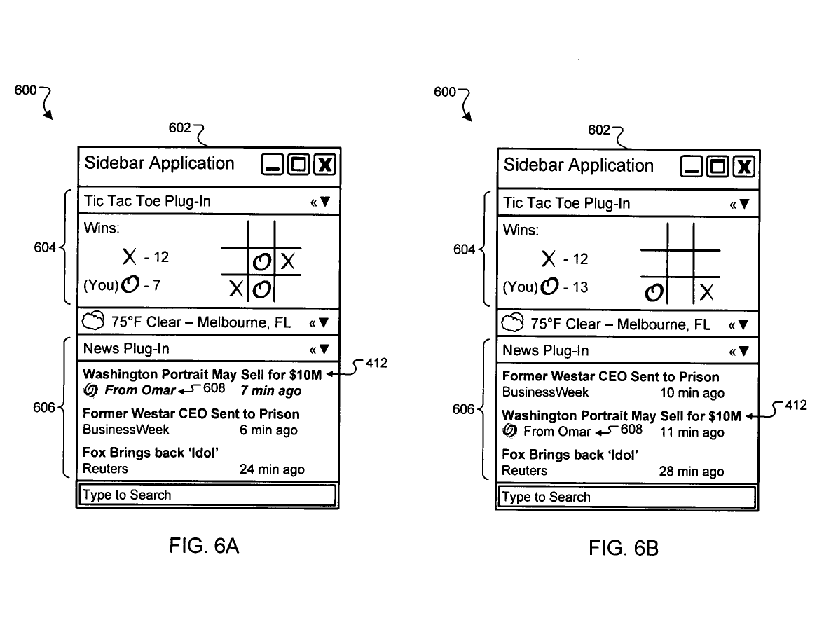

FIG. 6A is an example of a sidebar application UI 600 showing shared content that has been received. The UI 600 includes a sidebar application area 602. The sidebar application 210 of the client B 106 presents the area 602. The area 602 includes a tic-tac-toe plug-in area 604 and a news plug-in area 606 generated by the tic-tac-toe plug-in 224 and the news plug-in 218, respectively.

The news plug-in area 604 presents the item of interest 412 transmitted by the client A 102. In some implementations, the sidebar application 210 may present an item of interest received from a contact more prominently than other news items that were received from the RSS server 220. For example, the item of interest 412 may be displayed at the top of a list or the item of interest 412 or it may be presented using a bold color or font. The item can remain at the top of the list even if other items are subsequently received from external news servers through RSS feeds. The item of interest 412 may also include text 608 indicating the contact that shared the item 412.

FIG. 6B is an example of the sidebar application UI 600 showing shared content that has been received and selected. The user of the client B 106 may select the item of interest 412. Selecting the item 412 or performing an action associated with the selection of the item 412 may result in a decrease in the prominence of the item 412. For example, the list may be sorted in the order in which the news items were received, removing the item 412 from the top of the list. In addition, the color and font of the item 412 may change to a normal color and font for news items. In some implementations, selecting the item can open up a separate window with more information about the item, such as the complete news article for the portrait sale item of interest.

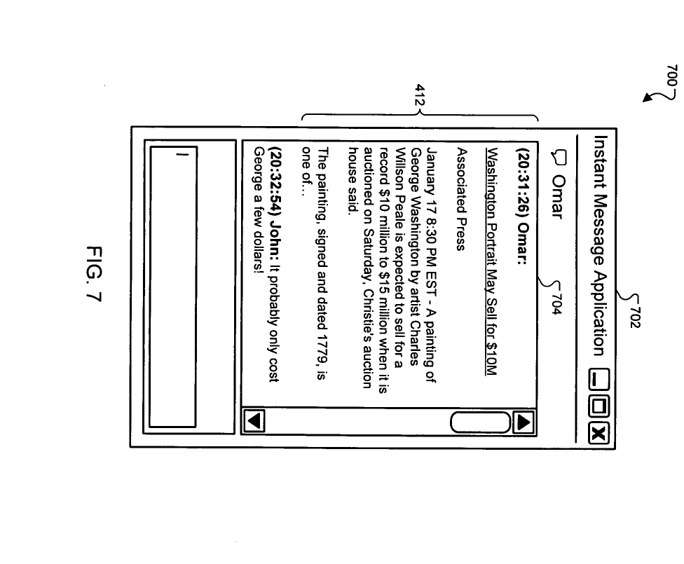

FIG. 7 is an example of an instant message application UI 700 showing shared content that has been received. The UI 700 includes an instant message application area 702 that may be presented by the instant message application 212. If, in FIG. 4, the user selects the option to send the item 412 to an instant message application, the instant message application 212 should receive the item 412. The instant message application 212 may present the item 412 in an instant message conversation area 704. The user of the client B 106 may then send an instant message reply to the user of the client A 102. In this way, the users of clients A and B may discuss the item of interest.

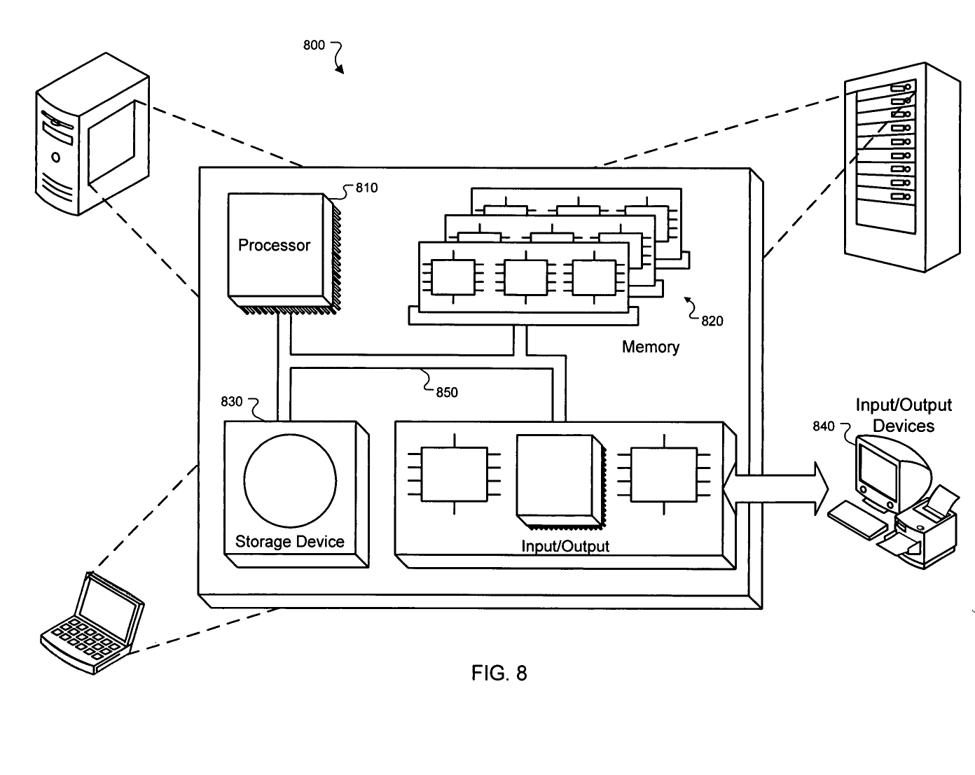

FIG. 8 is a schematic diagram of an example of a generic computer system 800. The system 800 can be used to perform the method 300 according to one implementation. For example, the system 800 may be included in either or all of the client A 104, the client B 106, the server 104, the news server 220, and the email server 230.

The system 800 includes a processor 810, a memory 820, a storage device 830, and an input/output device 840. Each of the components 810, 820, 830, and 840 are interconnected using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830 to display graphical information for a user interface, such as the UI 240, on the input/output device 840.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 may be a floppy disk device, a hard disk device, an optical disk device, or a tape device.

The input/output device 840 provides input/output operations for the system 800. In one implementation, the input/output device 840 includes a keyboard and/or pointing device. In another implementation, the input/output device 840 includes a display unit for displaying graphical user interfaces, such as the UI 240.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. For example, the client A 102 and the server 104 may be implemented within the same computer system.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of embodiments have been described. Nevertheless, it will be understood that various modifications may be made without departing from the spirit and scope of the described embodiments. For example, the list of contacts 422 presented to the user, which can determine where the item of interest is sent, can be generated using previously stored contact information in IM applications, email applications, cellular phone contacts, and personal digital assistant contacts.

In another implementation, users of the clients may pass interactive game moves as items of interest. For example, when a user of the client B selects an open area in the tic-tac-toe game displayed in the panel area 604, the sidebar application can transmit the move as an item of interest to the user of the client A. The transmitted move can appear as an “X” in the corresponding space on the tic-tac-toe panel of the client B's sidebar. In this way, two or more users can participate in interactive games by transmitting the moves between the clients' sidebars. Accordingly, other embodiments are within the scope of the following claims.

What is claimed is:

1. A computer implemented method comprising:
receiving an event associated with a user selection of an item displayed by a sidebar application running on a first client, the sidebar application being an application that is configurable to aggregate multiple types of items from sources external to the sidebar application;
receiving an identifier associated with an external client, the external client being different from the first client; and
initiating, using the sidebar application, transmission of the item to the external client.

2. The method of claim 1, further comprising selecting an application on the external client to receive the item.

3. The method of claim 2, wherein the application on the external client is another sidebar application, an email client, or an instant messaging client.

4. The method of claim 3, wherein the other sidebar application is configured to display the received item in a prominent manner.

5. The method of claim 4, wherein the other sidebar application is configured to decrease the prominence of the received item after the received item is selected by a user of the other sidebar application.

6. The method of claim 1, wherein the item is a plug-in panel for the sidebar application.

7. The method of claim 1, wherein the item is managed by a plug-in panel for the sidebar application, and wherein the item includes information that is encoded as a string.

8. The method of claim 7, wherein the item is selected from a group consisting of text from rich site summary (RSS) transmissions, email messages, web pages, digital images, and interactive game movements.

9. The method of claim 1, wherein the sidebar application uses plug-ins to aggregate the multiple types of items, wherein each plug-in uses the sidebar application to transmit items managed by the plug-in to the external client.

10. The method of claim 1, wherein transmitting the item includes the sidebar application accessing a communication interface of a second separate application, wherein the separate application transmits the item to the external client.

11. The method of claim 10, wherein the second separate application is an instant messaging application.

12. The method of claim 1, wherein transmitting the item includes using a communication interface that is integrated with the sidebar application for transmitting the item.

13. The method of claim 1, further comprising transmitting an identifier associated with the sender of the item.

14. The method of claim 1, further comprising terminating the transmission of the item if a user of the external client does not authorize acceptance of the transmission.

15. The method of claim 1, wherein transmitting the item includes transmitting the item from the first client to a server and from the server to the external client.

16. The system of claim 1, further comprising receiving at the first client a received item from another sidebar application on the external client and displaying the received item using the sidebar application running on the first client.

17. A system comprising:
a sidebar application configurable to aggregate for display multiple types of items received from sources external to the sidebar application; a user interface of the sidebar application operable to receive from a user an input selecting an item and an input selecting an external client to receive the item; and
means for transmitting the item from the sidebar application on a first client to the external client.

18. The system of claim 17, wherein the sidebar application includes plug-ins that manage the items.

19. The system of claim 17, wherein the means for transmitting is included in an application separate from the sidebar application, the means being used by the sidebar application to transmit the item to the external client.

20. A computer program product tangibly embodied in a tangible, machine-readable information carrier, the computer program product including instructions that, when executed, perform a method comprising:
receiving an event associated with a user selection of an item displayed by a sidebar application running on a first client, the sidebar application being an application that is configurable to aggregate multiple types of items from sources external to the sidebar application;
receiving an identifier associated with an external client, the external client being different from the first client; and
initiating, using the sidebar, transmission of the item to the external client.
